(19) United States
(12) Patent Application Publication
(10) Pub. No.: US 2025/0091248 A1
(43) Pub. Date: Mar. 20, 2025

(54) LARGE-SCALE STONE SLABS

(71) Applicant: Cambria Company LLC, Eden Prairie, MN (US)

(72) Inventors: Jon Louis Grzeskowiak II, Prior Lake, MN (US); Martin E. Davis, Excelsior, MN (US)

(21) Appl. No.: 18/889,634

(22) Filed: Sep. 19, 2024

Related U.S. Application Data
(60) Provisional application No. 63/539,203, filed on Sep. 19, 2023.

(51) Int. Cl. B28B 11/24; B28B 13/02

(52) U.S. Cl. CPC B28B 11/245; B28B 13/02

(57) ABSTRACT

The subject matter of this specification can be embodied in, among other things, a method of finishing a stone slab that includes receiving a stone slab having a major top surface having a first surface finish, and applying a second surface finish, different from the first surface finish, to modify a portion of the major top surface that is less than an entirety of the major top surface.

### RELATED APPLICATION

This application claims benefit to U.S. Provisional Application No. 63/539,203 filed Sep. 19, 2023, the subject matter of which is incorporated by reference in its entirety.

### TECHNICAL FIELD

This document describes systems and processes for forming stone slab products, for example, a processed stone slab that is thermoformed or otherwise compacted to a selected slab shape from a mixture including particulate mineral material, resin binder, and pigments so that the stone slab is suitable for use in living or working spaces (e.g., along a countertop, table, floor, or the like).

### BACKGROUND

Stone slabs are a commonly used building material. Granite, marble, soapstone, and other quarried stones are often selected for use as countertops due to their aesthetic properties. Stone slabs may also be formed from a combination of natural and other materials that can provide improved qualities such as aesthetic characteristics, reproducibility, and stain-resistant or heat-resistant properties. Stone slabs have been made from a combination of particulate mineral material and binder, such as a polymer resin or cement. Some stone slabs are manufactured to have a particular aesthetic appearance, such as an aesthetic appearance that has a predetermined pattern or design, emulates quarried stone, or that accentuates particular aesthetic features.

### SUMMARY

Some embodiments described herein include systems and processes for forming stone slabs suitable for use in living or working spaces. In some optional embodiments, slabs include one or more surface finishes generated by applying a sequence of abrasive polishing brushes. For example, some example slabs described herein include a portion having a glossy surface finish, a matte surface finish, a textured finish, and/or one or more other finishes. In some optional embodiments, regions of different surface finishes provide a visible dividing line, such as a line that extends across an entire dimension of the slab, such that the regions are visible to an observer. Slabs having a regions of different surface finishes can be used in living and working spaces, and/or as a visible example of different surface finishes (e.g., for display in a showroom).

In a general example, a process of finishing a stone slab includes receiving a stone slab having a major top surface having a first surface finish, and applying a second surface finish, different from the first surface finish, to modify a portion of the major top surface that is less than an entirety of the major top surface.

Various implementations can include some, all, or none of the following features. The modified portion of the major top surface can be a contiguous portion comprising substantially 50% of the major top surface. The modified portion can be visibly or tactilely distinct from an unmodified portion of the major top surface, and can define a boundary line that is visible, tactile, or both. The process can include at least partially filling a mold with a particulate mineral mix to create a layer of particulate mineral mix in the mold, curing the layer of particulate mineral mix into a cured slab, and providing the cured slab as the stone slab. The stone slab can have a slab width that is at least 2 feet, and a slab length that extends perpendicular to the slab width and that is at least 6 feet, the slab length and the slab width defining the top major surface. The first surface finish can be a matte finish, and the applied second surface finish can increase glossiness of the matte finish. The first surface finish can be a gloss finish and the applied second surface finish can reduce glossiness of the gloss finish. The process can include applying a third surface finish, different from the first surface finish and the second surface finish, to another portion of the major top surface different from the portion of the major top surface.

In another general example, a processed slab formed from at least one particulate mineral mix can include a slab width, a slab length that extends perpendicular to the slab width and is greater than the slab width, a slab thickness that extends perpendicular to the slab width and the slab length, the slab thickness less than the slab width, and a major top surface defined by the slab length and the slab width and included a first finished portion having a first surface finish, and a second finished portion that is less than an entirety of the major top surface and having a second surface finish different from the first surface finish.

Various embodiments can include some, all, or none of the following features. The first finished portion can contiguously extend across about one-half of the major top surface. The first finished portion can be distinguished from the second finished portion by a substantially straight boundary line. The first surface finish can be visually or tactilely distinguishable from the second surface finish. The slab width can be at least 2 feet and the slab length is at least 6 feet.

In another general example, a system for forming a stone slab having multiple different surface finishes includes a receiving table configured to receive a processed stone slab having a major top surface having a first surface finish, and a polisher configured to apply a second surface finish to modify a portion of the major top surface that is less than an entirety of the major top surface.

Various embodiments can include some, all, or none of the following features. The receiving table can be configured to hold the processed stone slab substantially stationary relative to the polisher, and the polisher can be configured to move a polisher head across the major top surface to modify the portion of the major top surface that is less than the entirety of the major top surface. The polisher can be configured to apply a predetermined sequence of a plurality of surface polishing processes to the portion of the major top surface. Each surface polishing process of the plurality of surface polishing processes include use of one or more of a predetermined polishing head, a predetermined polishing compound, a predetermined polishing head advance speed, a predetermined spindle rotational speed, a predetermined polishing head approach angle toward the top major surface, a predetermined polishing head linear direction, a predetermined water flow, a predetermined contour, and a predetermined application force. The portion of the major top surface can be partly defined by a visually or tactilely distinguishable straight border between the portion and a remainder of the major top surface. The first surface finish can be a matte finish, and the polisher can be configured to apply a gloss finish to the portion. The first surface finish can be a gloss finish, and the polisher can be configured to apply a matte finish to the portion. The receiving table can be configured to receive a slab width of at least 2 feet and a slab length of at least 6 feet.

The systems and techniques described here may provide one or more of the following advantages. First, a system can provide individual processed stone slabs that exhibit two or more distinct regions of different surface finishes. In some embodiments, the surface finishes are positioned adjacent to one another, providing a visual contrast between the different surface finishes.

Second, the system can modify and repurpose existing processed stone slabs, such as by modifying a surface finish on a portion or all of the existing processed stone slabs. In some example embodiments, the system can facilitate a surface finish having a predetermined characteristic.

Third, in some embodiments described herein, customized production of a stone slab having a predetermined surface characteristic that matches an existing stone slab (such as a stone slab produced at a different time, location, or previously installed in a work or living location) is facilitated. For example, a slab can be produced to have a particular surface characteristic to facilitate a seamless match with a particular existing stone slab. Some optional embodiments achieve a predetermined surface finish on a first stone slab using a first finishing technique (such as via a CNC polishing machine having a non-articulating head) that visibly matches a surface finish of a second slab generated using a second finishing technique (that does not utilize a CNC polishing machine having a non-articulating head).

Fourth, some embodiments described herein facilitate a unitary stone slab for installation in a working or living space having regions of distinct surface characteristics. Such slabs can facilitate installation in a single location while having distinct portions of visibly distinct surface finishes.

Sixth, some embodiments facilitate efficient slab handling and economical material usage by generating a unitary stone slab having multiple distinct regions of different surface finishes. For example, a single slab can be manufactured with distinct surfaces regions to facilitate subsequent fabrication and cutting operations that result in portions having different surface characteristics. In some embodiments, distinct portions of a single slab having similar material composition, colors, etc., and differing surface characteristics can be used in different portions of installations surfaces (e.g., flooring, wall covering, countertops, and/or different portions of such surfaces).

Seventh, the system can manufacture processed stone slabs that exhibit and promote customer choice. For example, some examples described herein facilitate manufacture of processed stone slabs that enhance consumer awareness and interest in processed stone slab products, and demonstrate different surface finishes on a unitary, consistent stone slab surface, such as in a showroom, sales center, or other marketing display. Some example embodiments facilitate an accurate comparison of available surface finishes by including distinct regions of different surface finishes on a single slab having a consistent material composition, color, etc.

The details of one or more implementations are set forth in the accompanying drawings and the description below. Other features and advantages will be apparent from the description and drawings, and from the claims.

### DESCRIPTION OF DRAWINGS

FIG. 1 is a top view of an example processed slab, in accordance with some embodiments.

FIG. 2 is a perspective view of an example processed, in accordance with some embodiments.

FIG. 3 is a diagram of an example system for applying a surface treatment to a processed slab product, in accordance with some embodiments.

FIGS. 4A and 4B are diagrams of example systems for applying surface treatments to processed slab products, in accordance with some embodiments.

FIG. 5 is a flow diagram of an example process for producing a processed slab product, in accordance with some embodiments.

FIG. 6 is a schematic diagram of an example of a generic computer system.

### DETAILED DESCRIPTION

In general, this document describes systems and techniques in which processed and cured (e.g., hardened) stone slabs can be processed to modify the surface finish within predetermined areas of the stone slabs. For example, a stone slab having a gloss surface finish on its major face can be processed to impart a predetermined matte finish to a predetermined region of the face. In another example, a stone slab having a matte surface finish on its major face can be processed to impart a predetermined gloss finish to a predetermined region of the face.

In use, processed stone slabs that have been modified to exhibit multiple surface finishes can be used to provide side-by-side visual comparisons of two or more surface finishes for marketing or other purposes. For example, otherwise similar stone slabs can be manufactured with either a predetermined gloss finish or a predetermined matte finish, and the stone slabs produced by the systems and techniques described herein can be provided as store or marketing displays that exhibit both finishes side-by-side on the same slab. In an example use, customers can view and touch the example slab to help them choose the surface finish they prefer, and then place an order for stone slab products having their preferred surface finish.

In another example use, the systems and techniques described herein can be used to modify a manufactured stone slab to match another stone slab. For example, a customer may already have stone slabs as part of an existing structure, and may wish to install additional slabs (e.g., a remodel to expand a kitchen). The existing slabs can be analyzed to measure the properties of their surface finish (e.g., an original finish or one that has been modified by age or use), and then new slabs can be modified to impart similar surface finish properties that match the already-installed slabs. In another example, a damaged existing slab may need replacement, and a new replacement slab can be modified to have a surface finish that substantially matches the finish of the existing slabs (e.g., so as to provide a clean seam between the new and old slabs that is not noticeable due to the consistent surface finishes). In another example, the surfaces of older slabs may be modified to match newly-manufactured slabs (e.g., to restore them to a factory finish, or to change them to a different appearance because a customer wants an updated look without having to completely replace their existing surfaces). In another example, the surfaces may be modified after installation to address issues not apparent prior to installation, such as to increase or decrease the reflection of sunlight or overhead lighting to reduce unexpected glare or to to make better use of insufficient room lighting.

In yet another example use, the systems and techniques described in this document can be used to modify a uniform surface finish for aesthetic or function purposes. For example, a customer may wish to build a shower enclosure out of stone slabs having a glossy surface finish, but the floor slab can be processed to impart a less matte or rough surface to all or part of the floor slab to make the floor less slippery when wet. In another example, slabs used for countertops and/or walls may be modified to have a pattern of two or more surface finishes (e.g., stripes or checkerboard) to enhance them more visible to people (e.g., to enhance depth perception) or to control lighting (e.g., reduce glare from the sun or overhead lights).

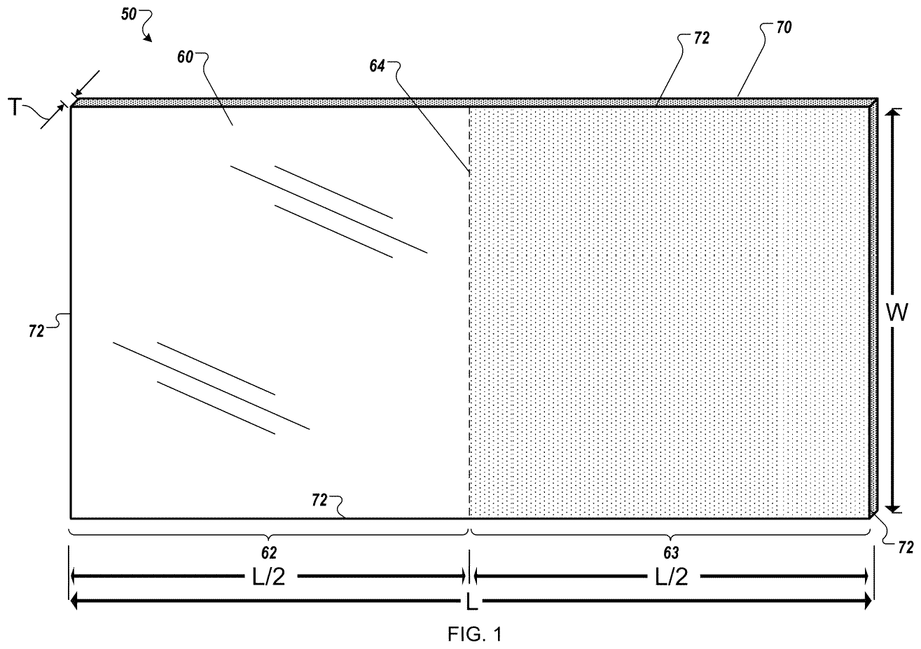

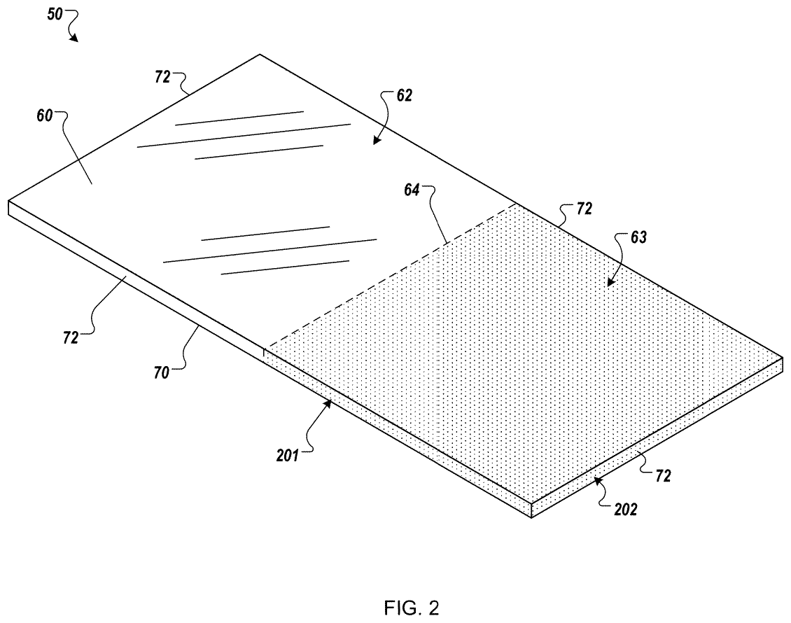

Referring to FIGS. 1 and 2, an example processed slab 50 is shown having a top major surface 60 with multiple different surface finishes. The top major surface 60 has a first finished portion 62 having a predetermined surface finish (e.g., gloss), and second finished portion 63 that has a different predetermined surface finish (e.g., matte). The first finished portion 62 is bounded from the second finished portion 63 by a boundary line 64. In the illustrated example, the first finished portion 62 occupies a contiguous portion of about one-half of the top major surface 60, and the second finished portion 63 occupies a contiguous portion of the remaining approximately one-half of the top major surface 60. In the illustrated example, the boundary line 64 is a visually or tactilely distinguishable straight border line or straight boundary line that extends perpendicular to two opposite edges of the processed slab 50, and is defined by a sharp, visible other tactilely perceptible transition between the different surface finishes of the first finished portion 62 and the second finished portion 63.

In various example embodiments, the processed slab 50 includes any number, combination, pattern, and/or proportion of particulate fills and mixes. For example, the processed slab 50 can include two, three, four, five, ten, or any appropriate number of particulate mineral mixes to provide any appropriate number of vein types. In some embodiments, the processed slab 50 includes one or more regions of different particulate mineral mixes and/or different surface characteristics (e.g., according to a predefined pattern).

The processed slab 50 has a slab width W and a slab length L (e.g., at least 2 feet wide by at least 6 feet long, and between about 3 feet and 5 feet wide and between about 6 feet and 14 feet long, preferably about 4.5 feet wide (more particularly, about 140 cm wide) by about 10 feet long (more particularly, about, 310 cm long)). In general, the length L and the width W define a top major surface 60 (e.g., face) and a bottom major surface (e.g., face) 70. The processed slab 50 also has a slab thickness T between the top major surface 60 and the bottom major surface 70. The periphery of the processed slab 50 includes a collection of edge faces 72.

Each slab 50 can comprise a quartz material and/or other particulate mineral material that, when mixed with pigments and a resin binder and subsequently compressed and cured, provides a hardened slab product suitable for use in living or working spaces (e.g., along a countertop, table, floor, or the like). Each slab 50 may be formed from a combination of particulate mineral mixes that have different hardness's and/or resistances to abrasion, and optionally different colors and textures. A slab mold is at least partly filled with a particulate mineral mix to create a layer of particulate mineral mix in the mold. The mold is closed and then transported for compaction and curing into a cured slab. The cured slab is subjected to abrading and other operations so as to provide the cured slab as the processed stone slab 50.

One or more of the mixes that are used to form the composite stone material can include organic polymer(s) and inorganic (mineral) particulate component. The inorganic (mineral) particulate component may include such components as silicon, basalt, glass, diamond, rocks, pebbles, shells, a variety of quartz containing materials, such as, for example, but not limited to: crushed quartz, sand, quartz particles, and the like, or any combination thereof. In this embodiment, all four different particulate mineral mixes each comprise a quartz material as a predominant component, which may include sand of various particle sizes and of different combinations. In the hardened, cured form of the slab 50, the organic and inorganic materials can be linked using a binder, which may include for example, mono-functional or multifunctional silane molecules, dendrimeric molecules, and the like, that may have the ability to bind the organic and inorganic components of the composite stone mix. The binders may further include a mixture of various components, such as initiators, hardeners, catalysators, binding molecules and bridges, or any combination thereof. Some or all of the mixes dispensed in the mold may include components that are combined in a mixing apparatus prior to being conveyed to the mold. The mixing apparatus can be used to blend raw material (such as the quartz material, organic polymers, unsaturated polymers, and the like) at various ratios. For example, some or all of the mixes of the processed slab 50 may include about 8-95% quartz aggregates to about 5-15% polymer resins. In addition, various additives may be added to the raw materials in the mixing apparatus, such additives may include metallic pieces (e.g., copper flecks or the like), colorants, dyes, pigments, chemical reagents, antimicrobial substances, fungicidal agents, and the like, or any combination thereof. In alternative embodiments, some or all of the quantity of quartz aggregates (mentioned above) can be replaced with or include porcelain and/or ceramic aggregate material.

The portions 62 and 63 each have a different appearance when observed and/or tactile feel when touched. In some embodiments, the differences in surface finishes can be due to difference in the properties and characteristics of the surfaces, including peak reflectance (e.g., RSpec), reflected image quality (e.g., RIQ), gloss (e.g., Gu), and/or roughness (e.g., Rz, Ra).

In some implementations, the portion an example gloss surface finish can have an RSpec in a range between about 7 to about 20, or a range between about 8 to about 15. In some implementations, an example gloss surface finish can have an RIQ in a range between about 35 to about 70, or a range between about 45 to about 60. In some implementations, an example gloss surface finish can have a gloss in a range between about 45 to about 70 Gu, or a range between about 50 to about 60 Gu. In some implementations, an example gloss surface finish can have an Rz in a range between about 1 to about 4, or a range between about 1.5 to about 3.

In some implementations, an example matte surface finish can have an RSpec in a range between about 0 to about 1, or a range between about 0.2 to about 0.4. In some implementations, an example matte surface finish can have an RIQ in a range between about 0 to about 10, or a range between about 0 to about 4. In some implementations, an example matte surface finish can have a gloss (60 degree) in a range between about 8 to about 20 Gu, or a range between about 12 to about 18 Gu. In some implementations, an example matte surface finish can have an Rz in a range between about 3 to about 10, or a range between about 4 to about 6.

In some implementations, the first finished portion 62 can differ from the second finished portion 63 by an RSpec of at least about 6.5. In some implementations, the first finished portion 62 can differ from the second finished portion 63 by an RIQ of at least about 42. In some implementations, the first finished portion 62 can differ from the second finished portion 63 by a gloss of at least about 25 Gu. In some implementations, the first finished portion 62 can differ from the second finished portion 63 by an Rz of at least about 1.

In some embodiments, such as for slabs having a high gloss finish, a goniophotometer (e.g., RHOPOINT 20-60-85 GLOSS HAZE DOI meter available from RHOPOINT INSTRUMENTS, HORIBA 60-Degree Gloss meter available from HORIBA) can be used to measure gloss at a predetermined angle and reflectance haze. For example, a goniophotometer is used to measure gloss at a predetermined angle of 20°, 60°, 85°, etc. The surface finish of some stone slabs can exhibit a gloss value (measured at an angle of) 60° of about 55 Gu and a reflectance haze of about 5 to about 17 (e.g., about 12) in an example embodiment. In some embodiments, such as for slabs having a matte finish, reflectance haze can be in a range of about 1.5 to about 8 (e.g., about 5) in an example embodiment.

The surface characteristics and aesthetics are, alternatively or additionally, measurable and quantifiable as a surface roughness. The surface roughness is measured by a surface roughness tester, such as a “Mitutoyo SJ-210” available from MITUTOYO, or “MarSurf PS 10” roughness meter available from MAHR GROUP, or a goniophotometer (e.g., RHOPOINT 20-60-85 GLOSS HAZE DOI meter available from RHOPOINT INSTRUMENTS, HORIBA 60-Degree Gloss meter available from HORIBA). For example, a roughness meter is used to measure a roughness of about 2 Rz for some glossy surface finishes, and a roughness of about 5 Rz for some matte surface finishes.

In some embodiments, the portions 62 and 63 can be emulative of predetermined surface finishes. For example, processed stone slabs can be manufactured to have a predetermined gloss surface finish or a predetermined matte finish. In some examples, a gloss slab can be processed such that about one half of its top face is modified to have surface properties that are substantially similar to the predetermined matte surface of the matte slabs. Conversely, in some examples, a matte slab can be processed such that about one half of its top face is modified to have surface properties that are substantially similar to the predetermined gloss surface of the gloss slabs.

In the illustrated examples, the slab 50 is configured with the boundary line 64 extending across the width W of the top major surface 60, perpendicular to the major edges 72. In some embodiments, the boundary line 64 can extend across the length L of the top major surface 60, parallel to the major edges 72. In some embodiments, the boundary line 64 can be arranged at any appropriate angle to the edges 72. In some embodiments, the boundary line 64 can be arranged such that the portions 62 and 63 are substantially unequal in surface area.

In some embodiments, surfaces of the slab 50 other than the top major surface 60 can be processed to impart a new or modified surface finish. For example, one or more of the edges 72 can be processed to have a predetermined surface finish across a predetermined portion or entirety of their surfaces, such as in an edge portion 201 and an edge portion 202 visible in FIG. 2. Likewise, the bottom major surface 70 can be processed to have a predetermined surface finish across a predetermined portion or entirety of its surface.

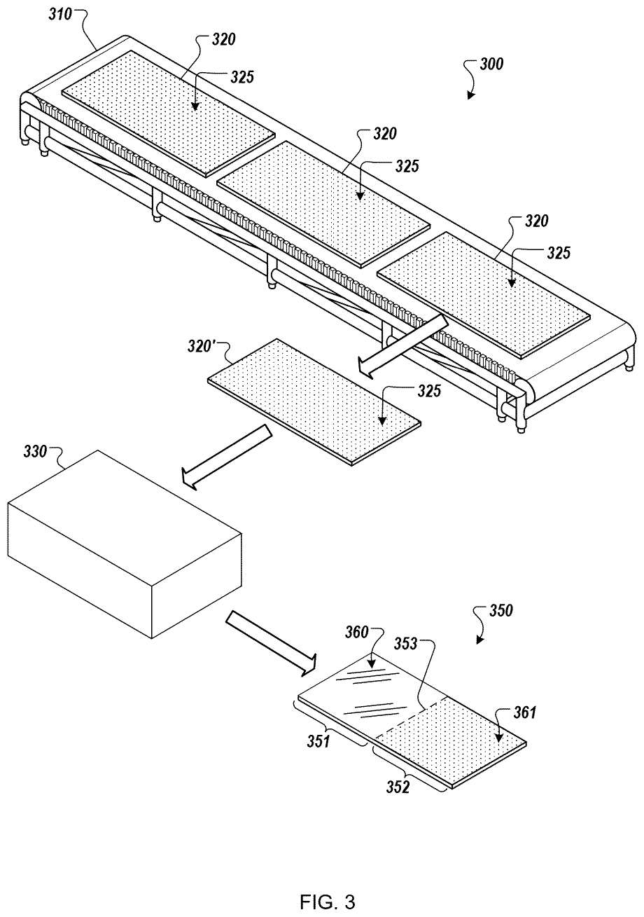

Referring now to FIG. 3, a diagram of an example system 300 for forming a processed slab product is shown. The system 300 includes a conveyor 310. In some embodiments, the system 300 for forming a set of processed slab products 320 is configured to dispense particulate mineral mixes into slab molds. The slab molds provide a form for processed molded slab products that are at least three feet wide and at least six feet long, and about 4.5 feet wide by about 10 feet long, for example. The slab molds are than advanced to a subsequent compression molding operation (e.g., vibro-compaction molding, curing, etc.) to produce the processed slab products 320.

A collection of processed slab products 320 is transported on the conveyor 310. In some embodiments, the collection of processed slab products 320 can be a collection of products that are being manufactured for sale. The processed slab products 320 each have a major top surface 325 having a predetermined surface finish (e.g., gloss, matte, textured, etc.) across substantially an entirety of the major top surface 325. For example, the system 300 can be a system for manufacturing multiple, substantially similar or identical processed slab products 320 (e.g., for sale to customers). In the illustrated example, the processed slab products 320 are manufactured to have a matte finish across substantially their entire major top surfaces 325.

One or more of the processed slab products 320 (e.g., 320′) can be selected for further surface processing. A surface finishing system 330 is configured to receive the processed slab product 320′ and apply a predetermined combination of abrasive and/or polishing processes in a predetermined step or sequence of steps in a surface polishing process to modify a predetermined region of the major top surface 325 (e.g., half of the major top surface 325). The surface finishing system 330 includes a receiving table configured to receive processed stone slabs, and a polisher configured to apply a surface finish to modify a portion (e.g., less than an entirety) of the major top surface of the received stone slabs.

The surface finishing system 330 is configured to apply a predetermined finish (e.g., gloss finish) to the initially matte finish of the processed slab product 320. In some embodiments, the processed slab products 320 can be produced with a generally gloss finish by default, and the surface finishing system 330 can be configured modify a portion (e.g., half) of the major top surface 325 by imparting a predetermined matte finish to the initially glossy surface.

In some implementations, the surface finishing system 330 can be configured to modify any appropriate surface finish to resemble any other appropriate surface finish. For example, the processed slab products 320 can be produced with any appropriate raw, matte, glossy, textured, or other surface across all or portions of their surfaces, and the surface finishing system 330 can be configured to convert such surface finishes to any other appropriate predetermined raw, matte, glossy, textured, or other surface across all or portions of their surfaces.

In some embodiments, the surface finishing system 330 can be a computer-aided manufacturing (CAM) system, such as a cartesian robotic system that is configured to perform a predetermined sequence of surface polishing processes in which a selectable end effector, polisher head, or tool is selected, applied, rotated, and/or drawn across the selected portion of the major top surface 325. Each pass of the sequence can include a predetermined combination of tool, tool center distance, tool vertical distance, circular radius of movement, direction of movement, spindle speed, advance speed, force, entry force, margin, water flow, contour, circular entry, circular exit, z-entry/exit, z-offset, tool offset, connect next, measure material, entry relative speed, slow entry acceleration, full force time, pneumatic activation, work z-offset, and/or other appropriate settings. Each pass of the sequence can include the use of a predetermined abrasive or polishing fluid(s) and/or compound(s). In some embodiments, the end effector tools can include polishing heads, grinding heads, brushes, and combinations of these and/or any other appropriate surface finishing tools.

In some embodiments, the surface finishing system 330 can be a predetermined surface finishing system. For example, the surface finishing system 330 can be a single-head, non-articulating head type polisher. In another example, the surface finishing system 300 can be an articulating head type polisher.

Upon completion of the surface treatment operation(s) performed by the surface finishing system 330, the modified processed slab product 320′ is provided as a multiple-finish processed slab product 350. In the illustrated example, the multiple-finish processed slab product 350 has a predetermined gloss surface finish 360 across a region 351 that includes approximately ½ of the major top surface 325, and a predetermined matte surface finish 361 across a region 352 that includes the remaining approximately ½ of the major top surface 325 of the unmodified remainder portion. The visible and/or tactile difference between the predetermined gloss surface finish 360 and the predetermined matte surface finish 361 defines a boundary line 353 that can be seen and/or felt. In some embodiments, the multiple-finish processed slab product 350 can be the example processed slab 50 of FIGS. 1 and 2.

In some implementations, the processed slab products 320 can be substantially unprocessed or unfinished at their major top surfaces 325 (e.g., uncalibrated, unfinished, not finished to a predetermined appearance or standard). In such examples, the surface finishing system 330 can be configured to apply the predetermined gloss surface finish 360 across the region 351 and apply the predetermined matte surface finish 361 across the region 352.

In some implementations, the surface finishing system 330 can modify the processed slab products 320 to have two, three, four, or any other appropriate number of predetermined surface finishes to a corresponding number of regions of the top surfaces 325. For example, a stone slab product may be available for sale in four different finishes, and the surface finishing system 330 can be configured to modify the processed slab product 320′ to have four distinct, bounded regions that exhibit the four different finishes on the multiple-finish processed slab product 350. The multiple-finish processed slab product 350 can then be put on display for customers to view and help them select which of the four finishes they would like to order.

In some implementations, the surface finishing system 330 can modify the processed slab products 320 to have two, three, four, or any other appropriate number of predetermined surface finishes in a predetermined pattern across the top surfaces 325. For example, the surface finishing system 330 can be configured to produce the multiple-finish processed slab product 350 with a striped, checkerboard, concentric, or any other appropriate pattern of predetermined glossy and matte regions.

In some implementations, the surface finishing system 330 can modify the processed slab products 320 to become a predetermined variety of processed slab products. For example, in some implementations the processed slab products 320 can initially be produced with a predetermined surface finish (e.g., a variant with the highest volume of sales), and then selected ones of the processed slab products 320 can be modified by the surface finishing system 330 to become other related products (e.g., variants with lower sales volumes, custom-ordered surface finishes, specialty finishes, custom finish patterns). In such implementations, the surface finishing system 330 can be used to avoid the overhead costs and/or space associated with the use of separate manufacturing lines that are dedicated to producing otherwise similar slab products having different surface finishes.

In some implementations, the surface finishing system 330 can be used to reduce or avoid inventory costs. For example, a variant of the with the processed slab products 320 with highest volume of sales can be produced and placed in inventory in order to buffer surges in consumer demand (e.g., made to stock). When an order is received for a slab variant having a surface finish that is less frequently ordered, one of the high-volume slabs can be retrieved from inventory and reprocessed into the requested variant (e.g., made to order).

In some implementations, the surface finishing system 330 can be used to improve material usage. For example, three orders may be received for three less-than-entire slab products having three different surface finishes. The processed slab product 320′ can be finished with the three requested surface finishes in three regions from which the three requested less-than-entire slab products can be cut. In such examples, a single source slab can be processed into multiple smaller slab products, and leave relatively less waste behind.

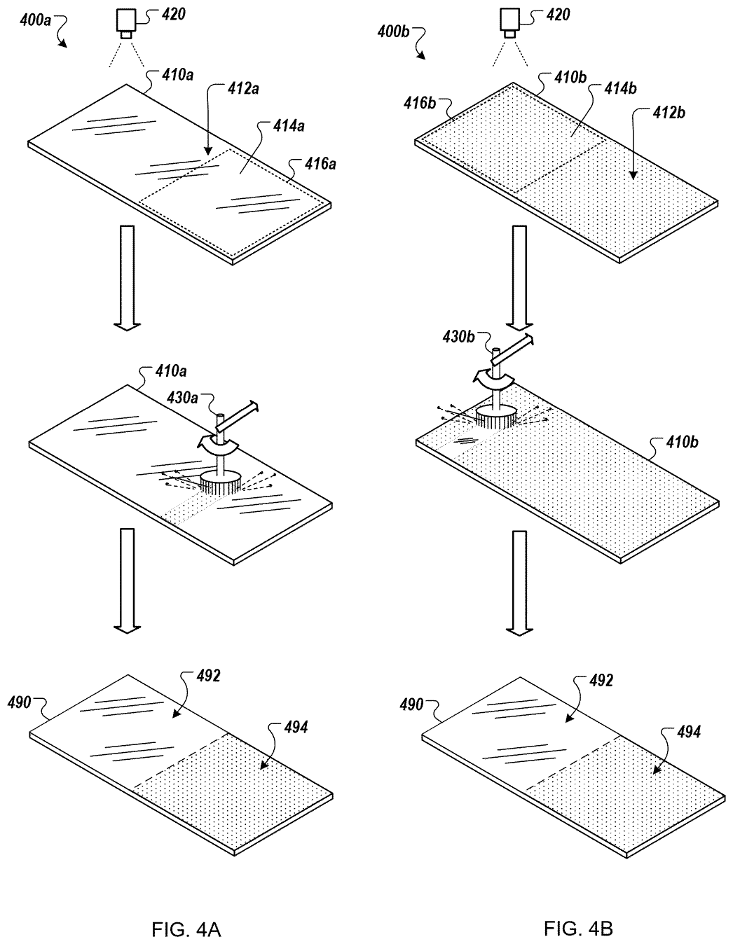

FIG. 4A is a diagram of an example system 400a for applying a surface treatment to a processed slab product. FIG. 4B is a diagram of an example system 400b for applying a surface treatment to a processed slab product. The illustrated examples in FIGS. 4A and 4B show that a processed stone slab 490 having two or more different surface finishes can be produced from two (or more) different types of source slabs.

In the example of FIG. 4A, the system 400a receives a processed slab 410a. The processed slab 410a has a predetermined gloss surface finish 412a across the entirety of a major top surface 414a of the slab. A digitizer 420 captures one or more images of the processed slab 410a, and an operator can use the captured image(s) to identify an area 416a in which the predetermined gloss surface finish 412a is to be modified to become a predetermined matte finish.

A finishing tool 430a (e.g., polisher head) and finishing compound are applied to the identified area 416a to modify the predetermined gloss surface finish 412a. In operation, a predetermined sequence of operations or process passes can be performed at this stage. In some implementations, each operation in the sequence can include a different predetermined tool that is moved in a predetermined way, and/or can include a different predetermined abrasive that is applied at a predetermined rate. For example, an example processing stage can have a polishing head move primarily along an x-axis while applying an aggressive abrasive compound, while another example processing stage can have a rotating brush move primarily along a y-axis while applying a mild polishing compound.

In some implementations, the finishing tool 430a can be purposedly configured to move along a selected path (e.g., the boundary between the identified area 416a and the remainder of the major top surface 414a) for one, two, or more processing stages. For example, some processing stages can purposely move the finishing tool 430a along different paths in order to avoid leaving visible tacks in the resulting surface finish. However, in the illustrated examples, a distinct and visible boundary between the processed and default surface finishes is desirable. As such, the finishing tool 430a can be purposely configured to move along the same path during multiple processing steps in order to purposely impart perceptible boundary lines between surface finishes.

In some implementations, the finishing tool 430a can be purposedly configured to end one or more selected paths along a predetermined line (e.g., the boundary between the identified area 416a and the remainder of the major top surface 414a). For example, some processing stages can purposely vary the start and/or end points of motion paths of the finishing tool 430a to avoid creating visible tacks in the resulting surface finish. However, in the illustrated examples, a distinct and visible boundary between the processed and default surface finishes is desirable. As such, the finishing tool 430a can be purposely configured to start and/or end tool paths along the same line during multiple processing steps in order to purposely impart perceptible boundary lines between surface finishes.

The surface processing modifies the predetermined gloss surface finish 412a to become a predetermined matte finish in the identified area 416a, transforming the processed slab 410a into the processed slab 490 in which a portion 492 of the top surface displays the original predetermined gloss surface finish and a modified portion 494 displays a predetermined matte surface finish.

In the example of FIG. 4B, the system 400b receives a processed slab 410b. The processed slab 410b has a predetermined matte surface finish 412b across the entirety of a major top surface 414b of the slab. The digitizer 420 captures one or more images of the processed slab 410b, and an operator can use the captured image(s) to identify an area 416b in which the predetermined matte surface finish 412b is to be modified to become a predetermined gloss finish.

A finishing tool 430b (e.g., polisher head) and finishing compound are applied to the identified area 416b in a way that increases glossiness of the predetermined matte surface finish 412b. The surface processing modifies the predetermined matte surface finish 412b to become a predetermined gloss finish in the identified area 416b, transforming the processed slab 410b into the processed slab 490 in which the portion 492 of the top surface displays the original predetermined gloss surface finish and the modified portion 494 displays a predetermined matte surface finish.

In some implementations, in order to produce a visibly distinct boundary or straight line between the portion 492 and the modified portion 494, a number of considerations can be taken into account. For example, the dividing line can be drawn during a digitizing phase, and all abrasives can be kept open (e.g., diamonds exposed). To make a narrow transition phase from one finish to the modified finish, the unmodified portion at the boundary can be narrowed as much as possible, or use surface specifications outside of what it desired for each intended finish. The process can be configured to produce as few scratches, smudges, or marks as possible at the boundary. In some implementations, it can be desirable to preserve the previous finish (e.g., without starting from a honed finish), and altering the previous finish to create desired modified finish. Abrasives can be set to a substantially identical outer radius on each polishing tool (e.g., head, disk). Contour can be selected on some passes but not all (e.g., to avoid polishing lines). The selection of contours can be a compromise that can promote the production of a narrow dividing transition line.

In some implementations, in order to avoid polishing circles, polish marks, lines, and other such artifacts on the modified portion, several additional factors can be taken into consideration as parts of the surface finishing process. For example, the direction of movement of the polishing head can be changed on each pass or on predetermined passes (e.g., general angle of looping tool path across the slab). In another example, a contour setting may be not selected on all passes (e.g., trace outside of selected area with polishing tool). For example, sow entry and/or exit can be implemented (e.g., not a hard stop/start). For example, circular entry and/or exit can be implemented (e.g., tool does not set down on one spot before moving—it lowers in a circular pattern).

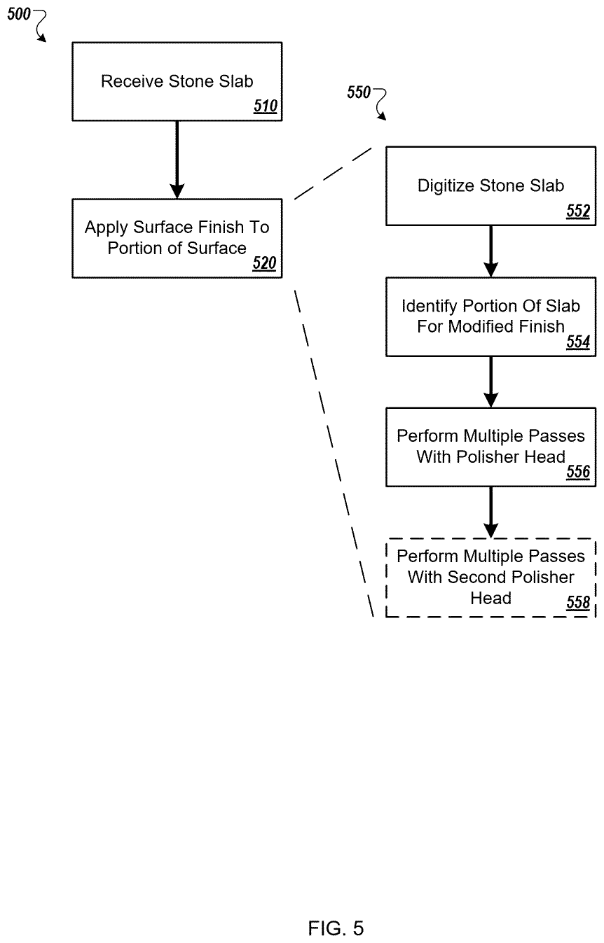

FIG. 5 is a flow diagram of an example process 500 for producing a processed slab product, in accordance with some embodiments. In some examples, the process 500 can be performed by all or part of the example surface finishing system 330 or FIG. 3, the example system 400a of FIG. 4A, or example system 400b of FIG. 4B.

At 510, a stone slab is received. The stone slab has a major top surface having a first surface finish. For example, the example surface finishing system 330 can receive the processed slab product 320′. In some implementations, the stone slab can have a slab width that is at least 2 feet, and a slab length that extends perpendicular to the slab width and that is at least 6 feet, the slab length and the slab width defining the top major surface.

At 520, a second surface finish, different from the first surface finish, is applied to modify a portion of the major top surface that is less than an entirety of the major top surface. For example, the surface finishing system 330 can apply a gloss surface finish to the initially matte surface finish within the region 351.

In some implementations, the major top surface of the received stone slab can have a matte finish, and the applied second surface finish can increase the glossiness of the matte finish. For example, the example system 400b if FIG. 4B can start with a substantially matte slab and can polish the area 416b to increase the glossiness of the initially matte finish within that area.

In some implementations, the major top surface of the received stone slab can have a gloss finish and the applied second surface finish can reduce glossiness of the gloss finish. For example, the example system 400a if FIG. 4A can start with a substantially glossy slab and can process the area 416a to reduce the glossiness of the initially glossy finish within that area.

In some implementations, the modified portion of the major top surface can be a contiguous portion comprising substantially 50% of the major top surface. For example, the example region 351 is contiguous and occupies approximately half of the major top surface 325.

In some implementations, the modified portion can be visibly or tactilely distinct from an unfinished unmodified portion of the major top surface, and can define a boundary line that is visible, tactile, or both. For example, the example gloss surface finish 360 can have a look and/or feel that is perceptibly different from the example matte surface finish 361.

In some implementations, the process 500 can include at least partially filling a mold with a particulate mineral mix to create a layer of particulate mineral mix in the mold, curing the layer of particulate mineral mix into a cured slab, and providing the cured slab as the stone slab. For example, the example conveyor 310 can be part of a manufacturing system that includes molds, particulate dispensers, compactors, curing stations, and combinations of these any other appropriate equipment used to manufacture processed slab products.

In some implementations, the process 500 can include applying a third surface finish, different from the first surface finish and the second surface finish, to another portion of the major top surface different from the portion of the major top surface. For example, the surface finishing system 330 can be configured to apply a third, fourth, or any other appropriate number of observably distinct surface finishes to a corresponding number of observably defined regions of the major top surface 325.

In some implementations, each surface polishing process can use of one or more of a predetermined polishing head, a predetermined polishing compound, a predetermined polishing head advance speed, a predetermined spindle rotational speed, a predetermined polishing head approach angle toward the top major surface, a predetermined polishing head linear direction, a predetermined water flow, a predetermined contour, and a predetermined application force. For example, the surface finishing system 330 can perform a predetermined sequence of operations that can each implement the use of their own predetermined selection of polishing tools, movement directions, movement speeds, abrasives/polishes, and any other appropriate surface processing tool, action, and/or compound in a predetermined sequence of one or more steps.

Process 550 is a process for producing a processed slab product, in accordance with some embodiments. For example, process 550 can be an implementation of example step 520.

At 552, a stone slab is digitized. In some implementations, digitizing a stone slab can includes digitally determining at least two edges of the slab and determining a dividing line between the at least two edges. For example, the dividing line can be a midpoint line between the two edges.

At 554, a portion of the stone slab identified for the application of a second finish based on the dividing line. In an example implementation, the portion can be approximately half of the major surface, for example, when the dividing line is the midpoint line. In some implementations, the portion can be less than or greater than half of the major surface.

At 556, a polisher head performs a collection of passes on the identified portion to apply the second finish, wherein at least one of the passes is proximate the dividing line. In an example implementation, a polisher head can be applied in an x-axis relative to the major surface, in a y-axis relative to the major surface, or in a direction not substantially in the x-axis or y-axis. In some implementations, the plurality of passes are on the identified portion but not the remaining, un-identified portion.

Optionally, at 558, the process 550 can further include making a collection of passes with a second polisher head on the identified portion. In an example implementation, the second polisher head can be applied in an x-axis relative to the major surface, in a y-axis relative to the major surface, or in a direction not substantially in the x-axis or y-axis.

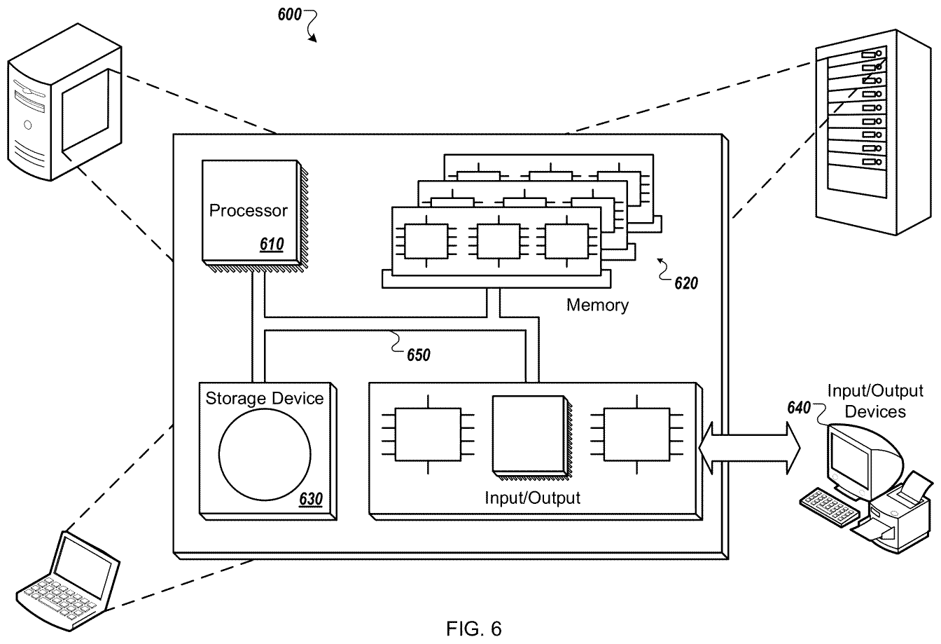

FIG. 6 is a schematic diagram of an example of a generic computer system 600. The system 600 can be used for the operations described in association with the method 300 according to one implementation. For example, the system 600 may be included in either or all of the example surface finishing system 330 or FIG. 3, the example system 400a of FIG. 4A, or example system 400b of FIG. 4B.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A process of finishing a stone slab, comprising:
receiving a stone slab having a major top surface having a first surface finish; and
applying a second surface finish, different from the first surface finish, to modify a portion of the major top surface that is less than an entirety of the major top surface.

2. The process of claim 1, wherein the modified portion of the major top surface is a contiguous portion comprising substantially 50% of the major top surface.

3. The process of claim 1, wherein the modified portion is visibly or tactilely distinct from an unmodified portion of the major top surface, and defines a boundary line that is visible, tactile, or both.

4. The process of claim 1, further comprising:
at least partially filling a mold with a particulate mineral mix to create a layer of particulate mineral mix in the mold;
curing the layer of particulate mineral mix into a cured slab; and
providing the cured slab as the stone slab.

5. The process of claim 1, wherein the stone slab has a slab width that is at least 2 feet, and a slab length that extends perpendicular to the slab width and that is at least 6 feet, the slab length and the slab width defining the top major surface.

6. The process of claim 1, wherein the first surface finish is a matte finish, and the applied second surface finish increases glossiness of the matte finish.

7. The process of claim 1, wherein the first surface finish is a gloss finish and the applied second surface finish reduces glossiness of the gloss finish.

8. The process of claim 1, further comprising applying a third surface finish, different from the first surface finish and the second surface finish, to another portion of the major top surface different from the portion of the major top surface.

9. A processed slab formed from at least one particulate mineral mix, comprising:
a slab width;
a slab length that extends perpendicular to the slab width and is greater than the slab width;
a slab thickness that extends perpendicular to the slab width and the slab length, the slab thickness less than the slab width; and
a major top surface defined by the slab length and the slab width and comprising:
a first finished portion having a first surface finish; and
a second finished portion that is less than an entirety of the major top surface and having a second surface finish different from the first surface finish.

10. The processed slab of claim 9, wherein the first finished portion contiguously extends across about one-half of the major top surface.

11. The processed slab of claim 9, wherein the first finished portion is distinguished from the second finished portion by a substantially straight boundary line.

12. The processed slab of claim 9, wherein the first surface finish is visually or tactilely distinguishable from the second surface finish.

13. The processed slab of claim 9, wherein the slab width is at least 2 feet and the slab length is at least 6 feet.

14. A system for forming a stone slab having multiple different surface finishes, comprising:
a receiving table configured to receive a processed stone slab having a major top surface having a first surface finish; and
a polisher configured to apply a second surface finish to modify a portion of the major top surface that is less than an entirety of the major top surface.

15. The system of claim 14, wherein:
the receiving table is configured to hold the processed stone slab substantially stationary relative to the polisher; and
the polisher is configured to move a polisher head across the major top surface to modify the portion of the major top surface that is less than the entirety of the major top surface.

16. The system of claim 14, wherein the polisher is configured to apply a predetermined sequence of a plurality of surface polishing processes to the portion of the major top surface.

17. The system of claim 16, wherein each surface polishing process of the plurality of surface polishing processes comprises use of one or more of a predetermined polishing head, a predetermined polishing compound, a predetermined polishing head advance speed, a predetermined spindle rotational speed, a predetermined polishing head approach angle toward the top major surface, a predetermined polishing head linear direction, a predetermined water flow, a predetermined contour, and a predetermined application force.

18. The system of claim 14, wherein the portion of the major top surface is partly defined by a visually or tactilely distinguishable straight border between the portion and a remainder of the major top surface.

19. The system of claim 14, wherein the first surface finish is a matte finish, and the polisher is configured to apply a gloss finish to the portion.

20. The system of claim 14, wherein the first surface finish is a gloss finish, and the polisher is configured to apply a matte finish to the portion.

21. The system of claim 14, wherein the receiving table is configured to receive a slab width of at least 2 feet and a slab length of at least 6 feet.
